(19) United States
(12) Patent Application Publication
(10) Pub. No.: US 2023/0402583 A1
(43) Pub. Date: Dec. 14, 2023

(54) Cathode Active Material, and Lithium Ion Battery Comprising Said Cathode Active Material

(71) Applicant: Bayerische Motoren Werke Aktiengesellschaft, Muenchen (DE)

(72) Inventors: Daniel BUCHHOLZ, Muenchen (DE); Tobias TEUFL, Poing (DE)

(21) Appl. No.: 18/033,469

(22) PCT Filed: Nov. 5, 2021
(86) PCT No.: PCT/EP2021/080771

§ 371 Date: Apr. 24, 2023

(30) Foreign Application Priority Data
Nov. 20, 2020 (DE) 10 2020 130 687.3

(51) Int. Cl. H01M 4/36; H01M 4/525; H01M 4/505; H01M 4/58; H01M 10/0525

(52) U.S. Cl. CPC H01M 4/364; H01M 4/525; H01M 4/505; H01M 4/5825; H01M 10/0525; H01M 2004/028

(57) ABSTRACT

A cathode active material for a lithium ion battery includes a multitude of first particles that contain a cobalt-free lithium layered oxide, and a multitude of second particles that contain a phospho-olivine. A lithium ion battery includes a cathode containing the cathode active material.

### BACKGROUND AND SUMMARY

The invention relates to an active cathode material for a lithium ion battery and to a lithium ion battery having such an active cathode material.

The expression “lithium ion battery” is used synonymously hereinafter for all names of lithium-containing galvanic elements and cells that are commonplace in the prior art, for example lithium battery cell, lithium battery, lithium cell, lithium ion cell, lithium-polymer cell, lithium-polymer battery and lithium ion accumulator. In particular, rechargeable batteries (secondary batteries) are included. The lithium ion battery may also be a solid-state battery, for example a ceramic or polymer-based solid-state battery.

A lithium ion battery has at least two different electrodes: one positive electrode (cathode) and one negative electrode (anode). Each of these electrodes has at least one active material, with or without additions such as electrode binders and electrical conductivity additives.

In lithium ion batteries, both the active cathode material and the active anode material must be capable of reversibly accepting and releasing lithium ions. Suitable active cathode materials are known, for example, from EP 0 017 400 B1 and DE 3319939 A1.

In lithium ion batteries for electrically driven vehicles, layered lithium nickel manganese cobalt oxide (NMC for short) is frequently used as active cathode material since NMC is notable in particular for a high energy density. In order to increase the energy density of NMC, it is possible to increase the nickel content; for example, it is possible to use compositions such as Li(Ni_{0.6}Mn_{0.2}Co_{0.2})O₂ (NMC622 for short) or Li(Ni_{0.8}Mn_{0.1}Co_{0.1})O₂ (NMC811 for short). However, the high energy density of these materials is also accompanied by high costs, elevated reactivity and high safety demands on the construction of the battery cell.

One problem addressed in one aspect of the disclosure is to provide an improved active cathode material for a lithium ion battery which is notable in particular for maximum energy density with simultaneously reduced costs and/or improved safety. In addition, a lithium ion battery with such an active cathode material is to be specified.

These objects may be achieved by an active cathode material and a lithium ion battery according to the independent claims. Advantageous configurations and developments of the invention may be the subject of the dependent claims.

In one embodiment of the disclosure, the active cathode material comprises a multitude of first particles including or consisting of a cobalt-free layered lithium oxide. The cobalt-free layered lithium oxide is preferably a lithium nickel manganese oxide. In addition, the active cathode material comprises a multitude of second particles including or consisting of a phospho-olivine. The phospho-olivine is especially lithium iron phosphate (LFP) or lithium iron manganese phosphate (LFMP). The active cathode material is thus a mixed active cathode material containing first particles and second particles of the different materials.

The active cathode material proposed here, including both the first particles and the second particles, by comparison with pure NMC, is notable for lower costs and elevated intrinsic safety. More particularly, it has been found that the addition of the second particles of the phospho-olivine makes it possible to dispense with the element cobalt in the layered oxide, without significantly impairing the stability of the active cathode material. The active cathode material thus enables comparatively environmentally friendly and sustainable production of the cathode. The energy density of the mixed active cathode material is elevated here compared to a pure phospho-olivine.

In one configuration, the first particles include Li_{y}(Ni₁₋ₓMnₓ)O₂ with 0≤x≤1, in particular with 0.1≤x≤0.9, and 0.9≤y≤1.3. The cobalt-free layered lithium oxide in this case is a lithium nickel oxide, a lithium nickel manganese oxide or a lithium manganese oxide. It is possible that the layered oxide is a lithium-rich layered oxide (OLO, overlithiated layered oxide).

In an advantageous configuration, the manganese content x is >0.5. Preferably, x≥0.6 or even x≥0.7. In this case, the layered lithium oxide is a manganese-rich layered lithium oxide. In particular, the layered lithium oxide contains more manganese than nickel. By virtue of the high manganese content, the layered oxide is producible particularly inexpensively.

In at least one embodiment, the second particles include LiFePO₄ or LiFe_{1-y}Mn_{y}PO₄ and 0≤y<1, i.e. the phospho-olivine is lithium iron phosphate or a lithium iron manganese phosphate.

More preferably, the second particles include LiFe_{1-y}Mn_{y}PO₄ with 0.5≤y≤0.9. Such a manganese-rich lithium iron manganese phosphate is notable for a high energy density compared to lithium iron phosphate.

In at least one embodiment, a proportion of the first particles in the totality of the first and second particles is between 10% by weight and 90% by weight inclusive, preferably between 20% by weight and 80% by weight inclusive.

In a preferred configuration, the proportion of the first particles in the totality of the first and second particles is at least 70% by weight, especially between 70% by weight and 90% by weight inclusive, more preferably at least 80% by weight, especially between 80% by weight and 90% by weight inclusive. For example, the proportion of the first particles may be 85% by weight and the proportion of the second particles may be 15% by weight. In this way, it is possible to achieve a lithium ion battery which, by comparison with a lithium ion battery including only a layered oxide such as NMC as active cathode material, is notable for reduced costs and improved thermal stability coupled with only slightly reduced energy density.

In an alternative configuration, the proportion of the first particles in the totality of the first and second particles is not more than 50% by weight, especially between 10% by weight and 50% by weight inclusive, more preferably not more than 40% by weight, especially between 10% by weight and 40% by weight inclusive. For example, the proportion of the first particles may be 30% by weight and the proportion of the second particles may be 70% by weight. In this way, it is possible to achieve a lithium ion battery which, by comparison with a lithium ion battery including only a layered oxide such as NMC as active cathode material, is notable for considerably reduced costs and significantly improved thermal stability. The energy density in this case is higher than in a lithium ion battery including a pure phospho-olivine such as LFP as active cathode material. The improved thermal stability of the active cathode material in this configuration especially enables production of the lithium ion battery in a “cell-to-pack” approach, meaning that the active cathode material proposed here can be used to produce a lithium ion battery cell that is inserted directly into a battery pack. In the “cell to pack” approach, the lithium ion battery cells are not first installed in modules that together form a lithium ion battery, but assembled directly to give a battery pack.

The active cathode material may be processed by conventional electrode production processes to give a cathode (positive electrode) comprising, for example, the active cathode material, an electrode binder and an electrical conductivity additive, for example, conductive carbon black.

What is also proposed is a lithium ion battery having a cathode with the above-described active cathode material. The cathode may be produced, for example, from a coating composition comprising the active cathode material with the first particles and the second particles, an electrode binder and an electrical conductivity additive, for example, conductive carbon black. The lithium ion battery may comprise, for example, just a single battery cell or alternatively comprise one or more modules with multiple battery cells, wherein the battery cells may be connected in series and/or in parallel. The lithium ion battery comprises at least one cathode including the active cathode material, and an anode including at least one active anode material. In addition, the lithium ion battery may include the further constituents of a lithium ion battery that are known per se, especially current collectors, a separator and an electrolyte.

The lithium ion battery of this disclosure may especially be provided in a motor vehicle or in a portable device. The portable device may especially be a smartphone, a power tool, a tablet or a wearable. Alternatively, the lithium ion battery may also be used in a stationary energy storage means.

Further advantages and properties of the technology will be apparent from the description of a working example that follows in conjunction with the figures.

### BRIEF DESCRIPTION OF THE FIGURES

The individual figures show, in schematic form,

FIG. 1: the construction of a lithium ion battery in one working example, and

FIG. 2: the active cathode material applied to a current collector in the working example.

The constituents shown and the size ratios of the constituents to one another should not be considered to be to scale.

### DETAILED DESCRIPTION OF THE FIGURES

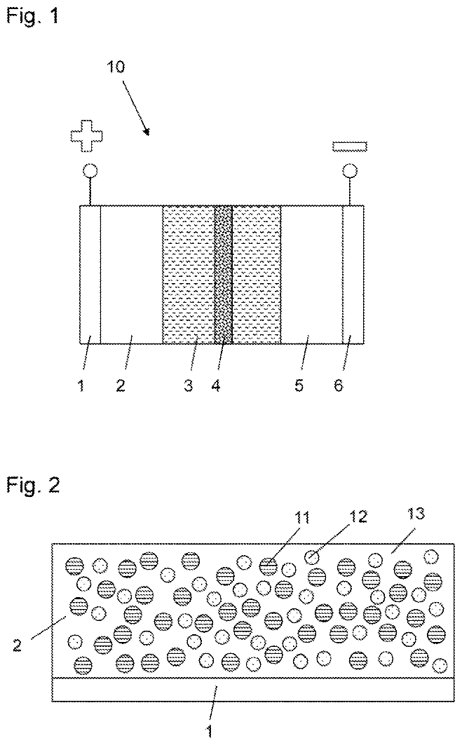

The lithium ion battery 10 shown purely schematically in FIG. 1 has a cathode 2 and an anode 5. The cathode 2 and the anode 5 each have a current collector 1, 6, where the current collectors may be designed as metal foils. The current collector 1 of the cathode 2 may include aluminum, for example, and the current collector 6 of the anode 5 may include copper.

The cathode 2 and the anode 5 are separated from one another by a separator 4 which is permeable to lithium ions but impermeable to electrons. Separators used may be polymers, especially a polymer selected from the group consisting of polyesters, especially polyethylene terephthalate, polyolefins, especially polyethylene and/or polypropylene, polyacrylonitriles, polyvinylidene fluoride, polyvinylidene-hexafluoropropylene, polyetherimide, polyimide, aramid, polyether, polyether ketone, synthetic spider silk or mixtures thereof. The separator may optionally additionally be coated with ceramic material and a binder, for example based on Al₂O₃.

In addition, the lithium ion battery has an electrolyte 3 which is conductive to lithium ions and which may be a solid-state electrolyte or a liquid comprising a solvent and at least one conductive lithium salt dissolved therein, for example lithium hexafluorophosphate (LiPF₆). The solvent is preferably inert. Suitable solvents are, for example, organic solvents such as ethylene carbonate, propylene carbonate, butylene carbonate, dimethyl carbonate, diethyl carbonate, ethyl methyl carbonate, fluoroethylene carbonate (FEC), sulfolane, 2-methyl-tetrahydrofuran, acetonitrile and 1,3-dioxolane. Solvents used may also be ionic liquids. Such ionic liquids contain exclusively ions. Preferred cations, which may especially be alkylated, are imidazolium, pyridinium, pyrrolidinium, guanidinium, uronium, thiuronium, piperidinium, morpholinium, sulfonium, ammonium and phosphonium cations. Examples of usable anions are halide, tetrafluoroborate, trifluoroacetate, triflate, hexafluorophosphate, phosphinate and tosylate anions. Illustrative ionic liquids include: N-methyl-N-propylpiperidinium bis(trifluoromethylsulfonyl)imide, N-methyl-N-butylpyrrolidinium bis(tri-fluoromethylsulfonyl)imide, N-butyl-N-trimethylammonium bis(trifluoromethylsulfonyl)imide, triethylsulfonium bis(trifluoromethylsulfonyl)imide and N,N-diethyl-N-methyl-N-(2-methoxyethyl)ammonium bis(trifluoromethyl-sulfonyl)imide. In one variant, two or more of the abovementioned liquids may be used. Preferred conductive salts are lithium salts that have inert anions and are preferably nontoxic. Suitable lithium salts are especially lithium hexafluorophosphate (LiPF₆), lithium tetrafluoroborate (LiBF₄) and mixtures of these salts. The separator 4 may be impregnated or wetted with the lithium salt electrolyte when it is liquid.

The anode 5 includes an active anode material. The active anode material may be selected from the group consisting of carbon-containing materials, silicon, silicon suboxide, silicon alloys, aluminum alloys, indium, indium alloys, tin, tin alloys, cobalt alloys and mixtures thereof. The active anode material is preferably selected from the group consisting of synthetic graphite, natural graphite, graphene, mesocarbon, doped carbon, hard carbon, soft carbon, fullerene, silicon-carbon composite, silicon, surface-coated silicon, silicon suboxide, silicon alloys, lithium, aluminum alloys, indium, tin alloys, cobalt alloys and mixtures thereof. In principle, further active anode materials known per se from the prior art are also suitable, for example including niobium pentoxide, titanium dioxide, titanates such as lithium titanate (Li₄Ti₅O₁₂), tin dioxide, lithium, lithium alloys and/or mixtures thereof.

FIG. 2 shows a schematic diagram of the cathode 2 on the current collector 1, which may especially be an aluminum foil. The cathode 2 includes an active cathode material. The active cathode material has a multitude of first particles 11 and second particles 12. The particles 11, 12 may be incorporated into an electrode binder 13, optionally with a conductivity-increasing additive, for example, a conductive carbon black.

The first particles 11 may include a cobalt-free layered oxide, especially Li(Ni₁₋ₓMnₓ)O₂ with 0≤x≤1. For the manganese content x, it is preferably the case that x>0.5, more preferably x≥0.6. The second particles 12 may include a phospho-olivine, especially LiFe_{1-y}Mn_{y}PO₄ with 0≤y<1. A particularly good relationship between costs and energy density may be achieved when the first particles 11 include a manganese-rich layered oxide, especially Li(Ni₁₋ₓMnₓ)O₂ with x>0.5, preferably x≥0.6, and the second particles 12 include a manganese-rich lithium iron manganese phosphate, especially LiFe_{1-y}Mn_{y}PO₄ with 0.5≤y≤0.9.

The proportion of the first particles 11 in the entirety of the particles 11, 12 may be between 10% and 90% inclusive, especially between 20% and 80% inclusive. In a configuration in which a maximum energy density is to be achieved at still moderate costs, the proportion of the first particles 11 may be between 70% and 90% inclusive, for example about 85%. The proportion of the second particles 12 in this case is correspondingly between 10% and 30% inclusive, for example about 15%.

In an alternative configuration, in which minimum costs are to be achieved at a still good energy density, the proportion of the first particles 11 may be between 10% and 50% inclusive, for example about 30%. The proportion of the second particles 12 in this case is correspondingly between 50% and 90% inclusive, for example about 70%.

Although the invention has been illustrated and described in detail with reference to working examples, the invention is not limited by the working examples. Instead, other variations of the invention can be inferred therefrom by the person skilled in the art without leaving the scope of protection of the invention as defined by the claims.

### LIST OF REFERENCE NUMERALS

1 current collector
2 cathode
3 electrolyte
4 separator
5 anode
6 current collector
lithium ion battery
11 first particles
12 second particles
13 electrode binder

1-10. (canceled)

11. An active cathode material for a lithium ion battery, the active cathode material comprising:
a plurality of first particles including a cobalt-free layered lithium oxide; and
a plurality of second particles including a phospho-olivine.

12. The active cathode material according to claim 11,
wherein the first particles include Li_{y}(Ni₁₋ₓMnₓ)O₂ with 0≤x≤1 and 0.9≤y≤1.3.

13. The active cathode material according to claim 12,
wherein x>0.5.

14. The active cathode material according to claim 13,
wherein x≥0.6.

15. The active cathode material according to claim 11,
wherein the second particles include LiFe_{1-y}Mn_{y}PO₄ with 0≤y<1.

16. The active cathode material according to claim 15,
wherein the second particles include LiFe_{1-y}Mn_{y}PO₄ with 0.5≤y≤0.9.

17. The active cathode material according to claim 11,
wherein a concentration of the first particles in a totality of the first and second particles is from 10% by weight to 90% by weight.

18. The active cathode material according to claim 11,
wherein a concentration of the first particles in a totality of the first and second particles is from 70% to 90% by weight.

19. The active cathode material according to claim 11,
wherein a concentration of the first particles in a totality of the first and second particles is from 10% by weight to 50% by weight.

20. A lithium ion battery comprising:
at least one cathode with an active cathode material according to claim 11.
